(19) United States
(12) Patent Application Publication
(10) Pub. No.: US 2026/0333016 A1
(43) Pub. Date: Oct. 22, 2026

(54) SYSTEMS AND METHODS FOR ONBOARDING A SUBSCRIBER ONTO A NETWORK

(71) Applicant: Verizon Patent and Licensing Inc., Basking Ridge, NJ (US)

(72) Inventors: Bharadwaj VEMURI, Jersey City, NJ (US); Axel HALLO DE WOLF, Whippany, NJ (US)

(73) Assignee: Verizon Patent and Licensing Inc., Basking Ridge, NJ (US)

(21) Appl. No.: 19/185,446

(22) Filed: Apr. 22, 2025

(51) Int. Cl. H04W 8/18; H04W 8/20; G06K 7/14

(52) U.S. Cl. CPC H04W 8/183; H04W 8/20; G06K 7/1417

(57) ABSTRACT

In some implementations, a subscriber device may scan a quick response (QR) code. The subscriber device may access a metadata uniform resource locator (URL) embedded within the QR code. The subscriber device may receive an indication of subscriber consent to download an embedded subscriber identity module (eSIM) profile associated with temporary access to a network. The subscriber device may transmit a subscriber device identifier. The subscriber device may download an eSIM profile that is associated with the subscriber device identifier based on the subscriber device satisfying an eligibility check. The subscriber device may install the eSIM profile. The subscriber device may access a network using the eSIM profile.

### BACKGROUND

The telecommunications industry is characterized by ongoing advancements that facilitate user connectivity and network access. User connectivity enhancements include innovations in subscription management and user integration methods for various telecommunications carriers.

### BRIEF DESCRIPTION OF THE DRAWINGS

FIGS. 1A-1E are diagrams of an example implementation associated with onboarding a temporary subscriber onto a network.

FIG. 2 is a diagram of an example environment in which systems and/or methods described herein may be implemented.

FIG. 3 is a diagram of example components of a device associated with onboarding a temporary subscriber onto a network.

FIG. 4 is a flowchart of an example process associated with onboarding a temporary subscriber onto a network.

### DETAILED DESCRIPTION OF EXAMPLE EMBODIMENTS

The following detailed description of example implementations refers to the accompanying drawings. The same reference numbers in different drawings may identify the same or similar elements.

The process of onboarding a subscriber to a mobile network, especially for short-term access at specific venues or points of interest, may be cumbersome and often requires manual input of device details and installation of carrier-specific applications. Additionally, the provisioning of temporary network access to non-subscribers, such as for special events or in certain high-traffic areas, presents logistical challenges in managing user consent, device eligibility, and ensuring a seamless customer experience. This is particularly relevant in environments like stadiums, where a large number of users may seek temporary network connectivity that is superior to their existing plans. Current solutions are limited by their reliance on manual data input, the need for live agent support, and the complexity of providing voice services, which may require additional customer verification (e.g., know your customer (KYC) information). Challenges remain in creating an intuitive, secure, and automated process for non-subscribers to quickly access and manage temporary mobile network services at specific venues without the need for additional applications or extensive manual data entry.

Some implementations described herein provide a method for efficiently onboarding a subscriber onto a network using an embedded subscriber identity module (eSIM) profile. For example, a subscriber device may use a native camera application to scan a quick response (QR) code at a point of interest, which may initiate access to a metadata uniform resource locator (URL) embedded within the QR code. Using the metadata URL, the subscriber device may receive an indication of subscriber consent to download an eSIM profile for temporary network access. In response, the subscriber device may transmit an identifier (e.g., an embedded identity document (EID)) to a network server, may download and install an associated eSIM profile, and may temporarily access the network.

In some examples, the network access may include access to data-only services, unless or until a subscriber transmits identity verification information (e.g., KYC information) to enable full-service access. Additionally, the metadata URL may be related to a network’s subscriber provisioning and management platforms. In some examples, the QR code may be strategically configured to provide conditional network access that correlates with the specific requirements of a venue or point of interest, such as a quantity of expected temporary subscribers, and the subscriber device may execute programmed instructions to display messages indicating the duration and expiration of network access. Upon the expiration of the temporary eSIM profile, the subscriber device may automatically transition to another network’s eSIM profile (e.g., a default eSIM profile associated with the subscriber device), optimizing network resource utilization. The eSIM profile may be managed post-installation through a web application, streamlining the technical process of eSIM administration without requiring a network-provider application to be installed at the subscriber device.

In this way, the techniques described herein enable fast and secure onboarding of users, both subscribers and non-subscribers, for temporary network access in targeted locations without the need for additional applications or manual data entry. The techniques may optimize network resource allocation by providing an automated and efficient process for managing temporary network connectivity, enabling operational efficiency at high-traffic events and venues. Moreover, the techniques described herein minimizes a need for live agent support manual processing of device information, while implementing robust security measures for subscriber consent and device eligibility verification.

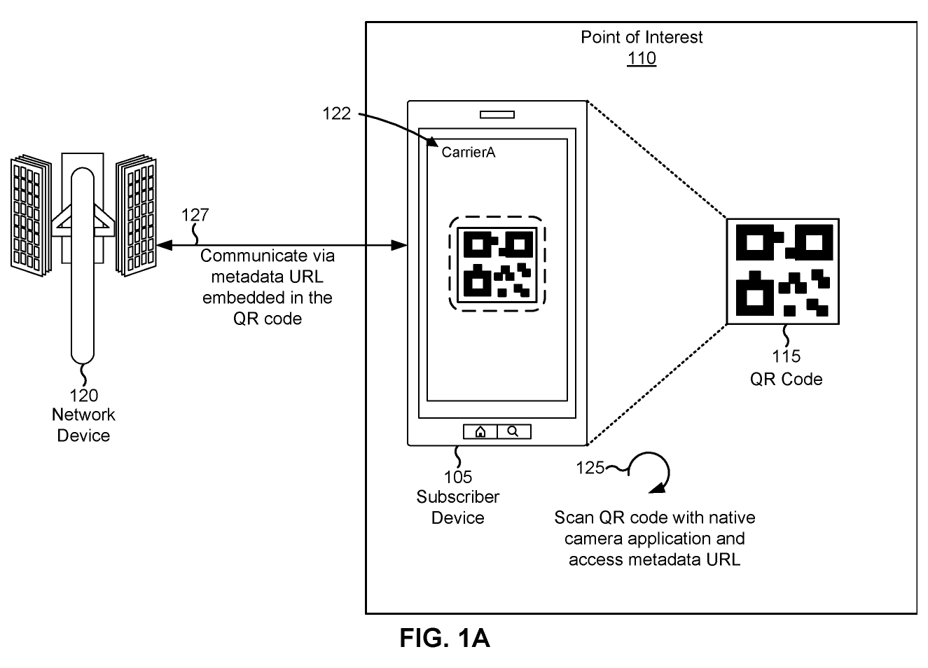

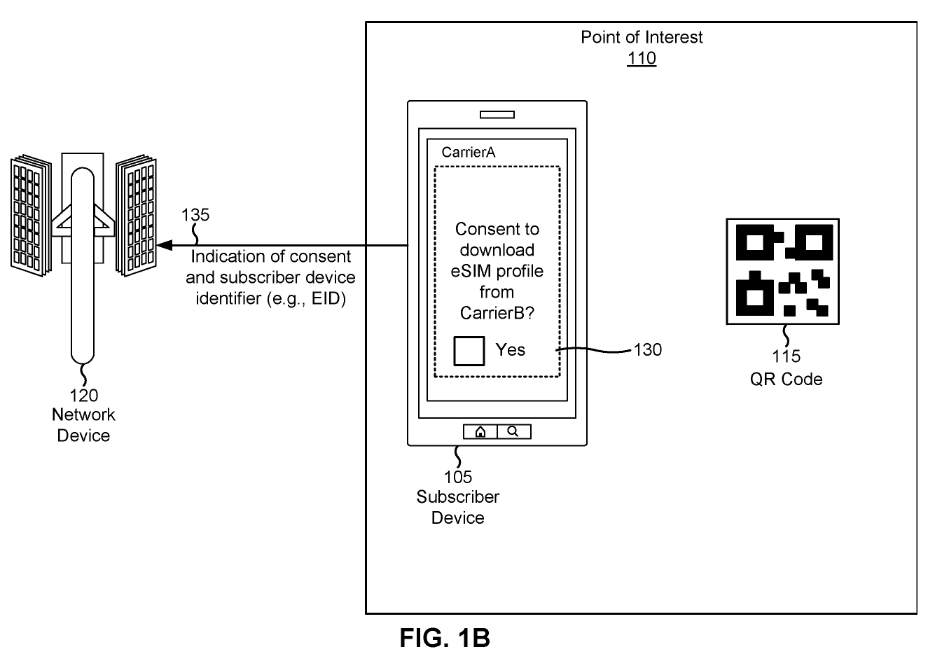

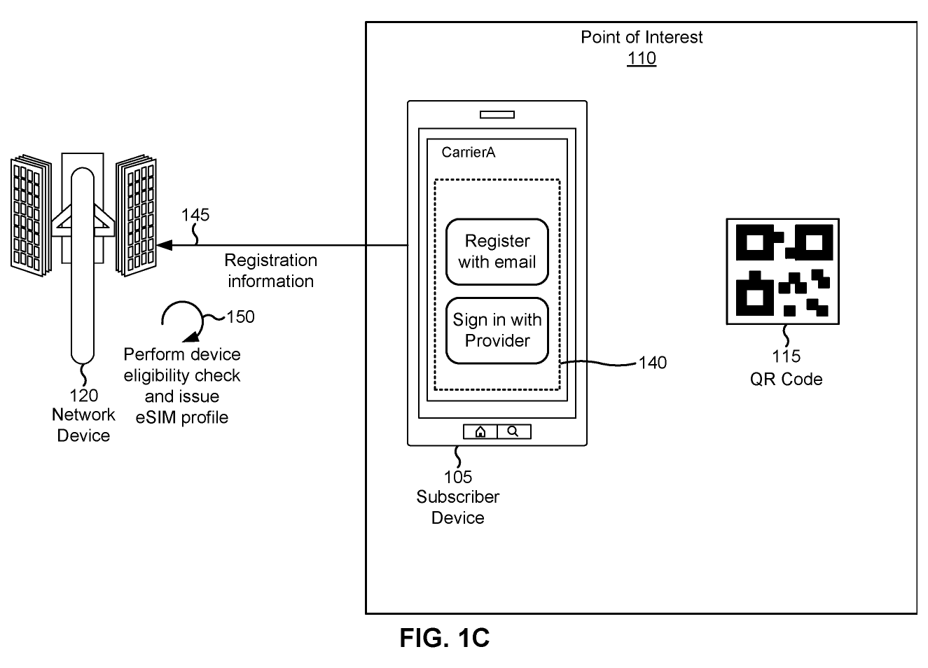

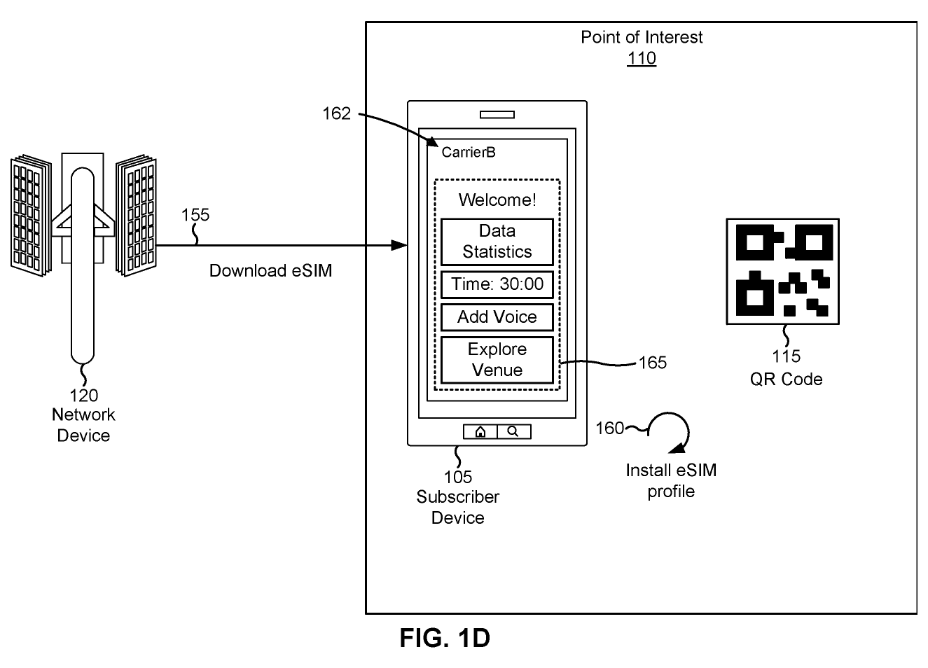

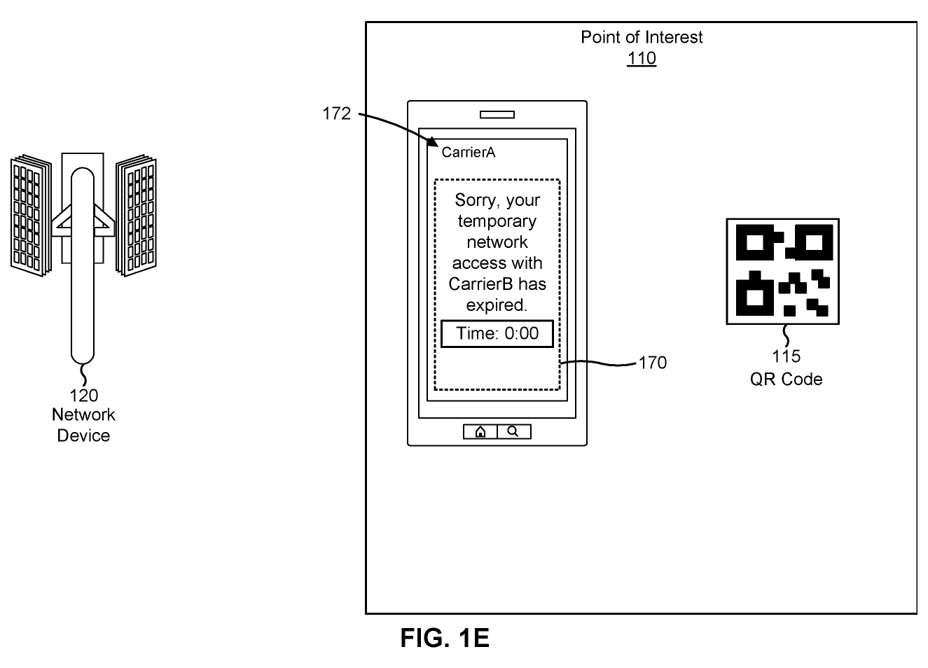

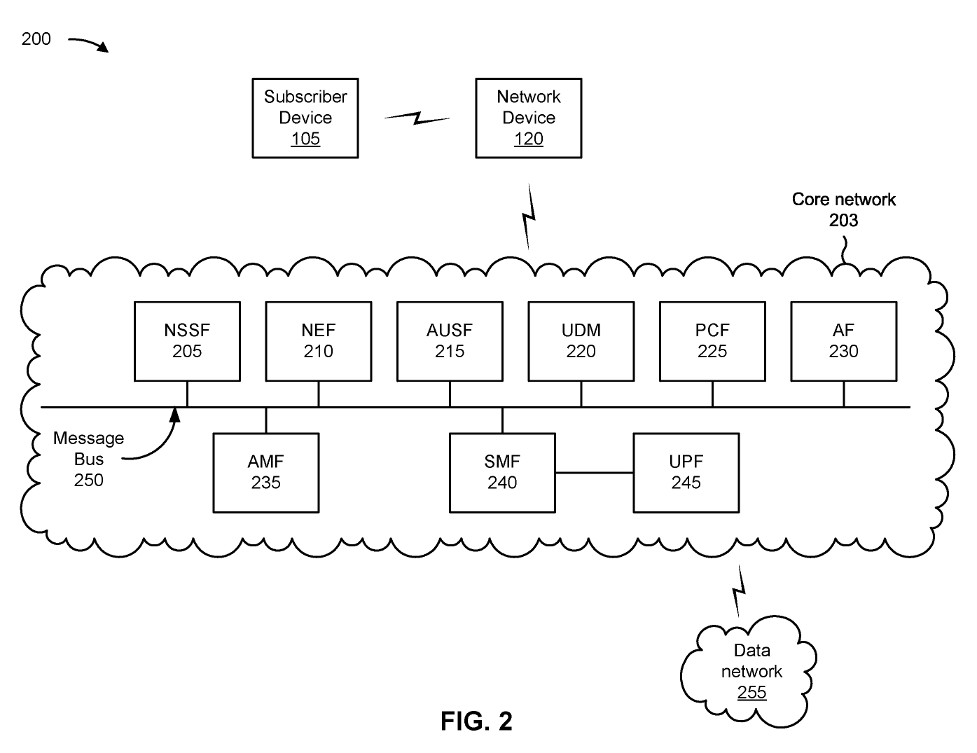

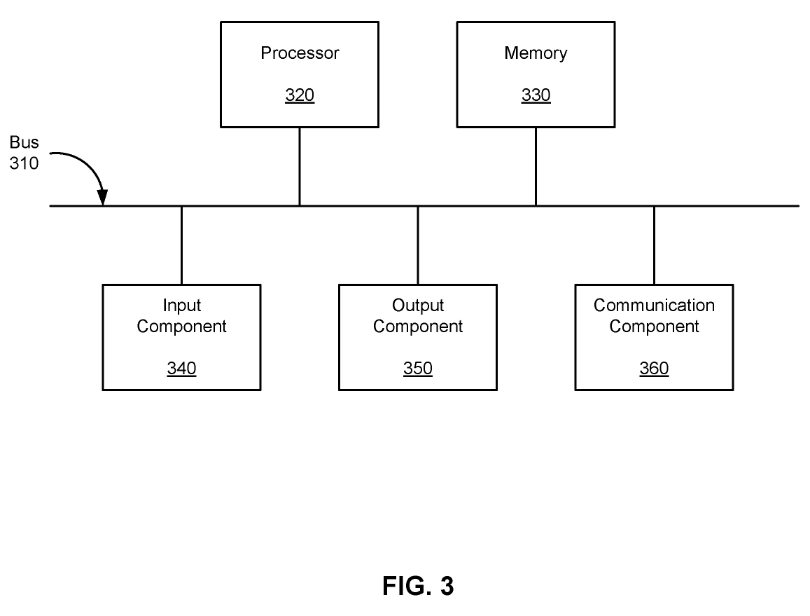

FIGS. 1A-1E are diagrams of an example implementation 100 associated with onboarding a temporary subscriber onto a network. As shown in FIGS. 1A-1E, example implementation 100 includes a subscriber device 105 located in a point of interest 110, such as a specific venue, stadium, building, or similar point of interest. The subscriber device 105 may be a device capable of connecting to a wireless network, such as a user equipment (UE), a mobile phone (e.g., a smart phone or a radiotelephone), a laptop computer, a tablet computer, a handheld computer, a gaming device, a wearable communication device (e.g., a smart watch or a pair of smart glasses), or a similar type of device. The point of interest 110 may be associated with a QR code 115 that may be used by the subscriber device 105 or other devices to gain temporary access to a network. In that regard, example implementation 100 further includes a network device 120 associated with the network, which may include one or more devices capable of providing connectivity to the network, such as a network server, a radio access network (RAN) component, a core network device, and/or a similar device. The subscriber device 105 and the network device 120 are described in more detail below in connection with FIGS. 2 and 3.

As shown by FIG. 1A, and by reference number 122, the subscriber device 105 may be associated with a default wireless network or carrier, shown as “CarrierA” in FIG. 1A. CarrierA may be a wireless network for which connectivity is poor in the point of interest 110. Accordingly, a user using the subscriber device 105 may wish to temporarily access a different wireless network or carrier, sometimes referred to herein as “CarrierB.” CarrierB may be a wireless network that provides enhanced coverage in the point of interest 110, such as via the network device 120. For example, when the point of interest 110 is a stadium or similar venue associated with many spectators, a wireless network provider (e.g., CarrierB) may deploy one or more network devices (e.g., network device 120) at the point of interest 110 to provide enhanced coverage or network access, among other examples.

As further shown in FIG. 1A, and by reference number 125, in order to temporarily gain access to the network, the subscriber device 105 may scan the QR code 115 using a native camera application of the subscriber device 105, such as for a purpose of accessing a metadata URL embedded in the QR code 115. The QR code 115 may be located in high-traffic venues, such as stadiums or event locations, facilitating easy access to temporary network services. The QR code 115 may be specifically configured for the point of interest 110 or the quantity of users expected to request temporary access to the point of interest 110. For example, the QR code 115 may be associated with a certain quantity of pre-provisioned eSIM profiles configured to provide temporary access to a wireless network associated with CarrierB. More particularly, if for a given event, game, or the like, it is expected that 10,000 users may request temporary access to the network, the QR code may be associated with 10,000 pre-provisioned eSIM profiles capable of providing temporary access to the network. In some implementations, scanning the QR code 115 by the subscriber device 105 may include capturing an image of the QR code 115 and processing the image to extract the metadata URL.

As further shown in FIG. 1A, and by reference number 127, the subscriber device 105 and the network device 120 may communicate via the metadata URL embedded in the QR code 115. For example, the subscriber device 105, upon accessing the metadata URL, may initiate a connection with the network device 120, as indicated by reference number 127. This metadata URL may facilitate the exchange of information between the subscriber device 105 and a network server to proceed with the onboarding process. In some aspects, the subscriber device 105 may communicate with the network server (e.g., the network device 120) via connectivity provided by a native or default network associated with the subscriber device 105, such as via CarrierA as shown in FIG. 1.

As shown by FIG. 1B, and reference number 130, the subscriber device 105 may receive an indication of subscriber consent to download an eSIM profile. For example, the metadata URL accessed by the subscriber device 105 may prompt a user of the subscriber device 105 to consent to downloading an eSIM profile associated with temporary access to the network. In such implementations, the subscriber device 105 may display a consent screen to the user, which may indicate various terms and conditions associated with temporary access to the network and/or which may enable a user to consent to an eSIM profile download from CarrierB.

As further shown in FIG. 1B, based on a user consenting to the eSIM download, among other examples, the subscriber device 105 may transmit, to the network device 120, an indication of user consent and/or a subscriber device identifier (e.g., an EID or similar identifier). For instance, upon receiving the user’s consent, the subscriber device 105 may transmit an identifier, such as an EID, to a network server associated with the network device 120, as indicated by reference number 135. In turn, the network server may authenticate the subscriber device 105 and/or associate the subscriber device 105 (e.g., associate an EID of the subscriber device 105) with an appropriate eSIM profile. In some aspects, transmitting the subscriber device identifier may include using an international mobile equipment identity (IMEI) number or similar identifier instead of, or in addition to, an EID.

As shown by FIG. 1C, and by reference numbers 140 and 145, the subscriber device 105 may transmit registration information to the network device 120. For example, as indicated by reference number 140, the subscriber device 105 may prompt a user associated with the subscriber device 105 to provide additional registration details, such as an email address or login information associated with an existing provider (e.g., an email provider, a cloud-based service provider, or a similar provider), facilitating the registration process for temporary network access. The subscriber device 105 may, in turn, transmit the registration information to the network server, as indicated by reference number 145. This step may ensure that the subscriber device 105 is eligible for the network services being offered. In some aspects, providing registration information may include using login credentials from a social media platform or other service to streamline the process, enabling users to quickly register using their existing accounts.

As further shown in FIG. 1C, and as indicated by reference number 150, the network device 120 may perform a device eligibility check and, if the subscriber device 105 is eligible to access the network, the network device 120 may issue an eSIM profile. For instance, once the registration information is received, the network device 120 may perform a device eligibility check to confirm that the subscriber device 105 meets the criteria for temporary network access. Upon successful verification, the network device 120 may issue the eSIM profile to the subscriber device 105. In some implementations, the device eligibility check may include cross-referencing the subscriber device 105’s identifier (e.g., EID) with a database of approved devices or a database indicating EIDs for which an eSIM was previously issued, among other examples, such as to ensure that devices pre-approved for temporary network access can proceed or to ensure that the device has not been previously issued an eSIM for temporary network access.

As shown by FIG. 1D, and reference number 155, the subscriber device 105 may download the eSIM profile from the network device 120. For example, following the eligibility check, the network device 120 may transmit the eSIM profile to the subscriber device 105, and the subscriber device 105 may download the eSIM profile and store the eSIM profile for temporary use. In some aspects, downloading the eSIM profile may include using a secure file transfer protocol (SFTP) instead of a direct network server connection to enhance security by ensuring the eSIM profile is transferred in a highly secure manner. Additionally, or alternatively, downloading the eSIM profile may include using a secure Hypertext Transfer Protocol Secure (HTTPS) connection to ensure that data is encrypted during transfer, providing an additional layer of security.

As further shown in FIG. 1D, the subscriber device 105 may install the eSIM profile, as indicated by reference number 160. For instance, once the eSIM profile is downloaded, the subscriber device 105 may install the profile to activate the temporary network services (e.g., network services associated with CarrierB, as indicated by reference number 162). In some implementations, the subscriber device 105 may display a message confirming the successful installation of the eSIM profile. In some other implementations, installing the eSIM profile may include automatically installing the profile without user intervention using a background service. Additionally, or alternatively, installing the eSIM profile may include notifying the user to manually confirm the installation through a system prompt.

As shown by FIG. 1D, and reference number 162, the subscriber device 105 may operate on the CarrierB network after successful installation of the eSIM profile. For example, the subscriber device 105 may indicate that it is connected to CarrierB, providing enhanced network coverage and connectivity within the point of interest 110. In some aspects, operating on the CarrierB network may include switching to the CarrierB network and displaying a notification indicating that it is now connected, enhancing the user’s awareness of the network change. Additionally, or alternatively, operating on the CarrierB network may include automatically updating network settings to prioritize connectivity to CarrierB to ensure optimal performance and coverage within the point of interest 110. Additionally, or alternatively, operating on the CarrierB network may include providing a visual indicator, such as a network icon change (as indicated by reference number 162), to signify successful connection to the CarrierB network.

As further shown by FIG. 1D, and reference number 165, once connected to the temporary network, the subscriber device 105 may enable management of the eSIM profile via a web application. For instance, after the eSIM profile is installed, the subscriber device 105 may provide the user with access to a web application that allows for managing various aspects of the eSIM profile, such as monitoring usage, renewing access, or adding additional services like voice capabilities or the like. Enabling management of the eSIM profile via a web application may streamline eSIM administration without requiring a network-provider application, or the like. Put another way, a user may be able to manage temporary network access to CarrierB without requiring the use of an application from CarrierB, among other examples.

In some aspects, the web application may display various information associated with the temporary network access. For example, as shown in FIG. 1D, the web application may display statistics associated with the data connectivity (e.g., average or peak download or upload speeds, among other information). Additionally, or alternatively, the web application may display a message indicating a duration of permitted access to the network, such as in implementations in which the temporary network access is limited to a specific duration. For example, as shown in FIG. 1D, the user may initially be permitted thirty minutes of access to the network, and thus the web application may initially indicate that the user has thirty minutes of remaining time. Moreover, the web application may include links enabling a user to interact with a specific venue, such as a venue associated with the point of interest 110. For example, the web application may include links to a map associated with the venue, menus for concessions stands or restaurants associated with venue, scores or team information associated with the venue (such as when the point of interest is a stadium associated with a sports match), or the like.

In some implementations, the network access may include access to data-only services. Put another way, the temporary network access to CarrierB may include a data-only plan. However, as further shown by reference number 165, in some implementations the web application may enable a user to add additional network services, such as voice services. For example, the web application may include links that enables a subscriber transmit identity verification information (e.g., KYC information) to enable full-service access to a network, such as voice access in addition to data access, among other examples. In this way, the subscriber device 105 may be configured to transmit identity verification information to the network device 120 and enable voice-based access to the network based on transmitting the identity verification information.

As shown in FIG. 1E, and by reference number 170, in some implementations the subscriber device 105 (e.g., the web application at the subscriber device 105) may display a notification based on expiration of a permitted access to the network. For example, returning the example above in which the subscriber device 105 is permitted thirty minutes of temporary access to the network (e.g., CarrierB), the subscriber device 105 may display a message indicating that the temporary access has expired once the thirty minutes has elapsed. Additionally, or alternatively, the subscriber device 105 may automatically switch to another eSIM profile that is associated with another network (e.g., a default eSIM profile associated with a default network, such as CarrierA) based on expiration of a permitted access to the network. For example, as indicated by reference number 172, based on the temporary access to the network associated with CarrierB expiring, the subscriber device 105 may switch to an eSIM profile associated with CarrierA (e.g., the network to which the subscriber device 105 was connected prior to establishing the temporary network access to the network associated with CarrierB).

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, example environment 200 may include the subscriber device 105 (e.g., a UE), the network device 120 (e.g., a RAN), a core network 203, and a data network 255. Devices and/or networks of example environment 200 may interconnect via wired connections, wireless connections, or a combination of wired and wireless connections.

The subscriber device 105 includes one or more devices capable of receiving, generating, storing, processing, and/or providing information, such as information described herein. For example, the subscriber device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The network device 120 may support, for example, a cellular radio access technology (RAT). The network device 120 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the subscriber device 105 (e.g., the UE). The network device 120 may transfer traffic between the subscriber device 105 (e.g., using a cellular RAT), one or more base stations (e.g., using a wireless interface or a backhaul interface, such as a wired backhaul interface), and/or core network 203. The network device 120 may provide one or more cells that cover geographic areas.

In some implementations, the network device 120 may perform scheduling and/or resource management for the subscriber device 105 covered by the network device 120 (e.g., the subscriber device 105 covered by a cell provided by the network device 120). In some implementations, the network device 120 may be controlled or coordinated by a network controller, which may perform load balancing, network-level configuration, and/or other operations. The network controller may communicate with the network device 120 via a wireless or wireline backhaul. In some implementations, the network device 120 may include a network controller, a self-organizing network (SON) module or component, or a similar module or component. In other words, the network device 120 may perform network control, scheduling, and/or network management functions (e.g., for uplink, downlink, and/or sidelink communications of the subscriber device 105 or other UEs covered by the network device 120).

In some implementations, core network 203 may include an example functional architecture in which systems and/or methods described herein may be implemented. For example, core network 203 may include an example architecture of a fifth generation (5G) next generation (NG) core network included in a 5G wireless telecommunications system. While the example architecture of core network 203 shown in FIG. 2 may be an example of a service-based architecture, in some implementations, core network 203 may be implemented as a reference-point architecture and/or a 4G core network, among other examples.

As shown in FIG. 2, core network 203 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

NSSF 205 includes one or more devices that select network slice instances for UEs (e.g., subscriber device 105). By providing network slicing, NSSF 205 allows an operator to deploy multiple substantially independent end-to-end networks potentially with the same infrastructure. In some implementations, each slice may be customized for different services.

NEF 210 includes one or more devices that support exposure of capabilities and/or events in the wireless telecommunications system to help other entities in the wireless telecommunications system discover network services.

AUSF 215 includes one or more devices that act as an authentication server and support the process of authenticating UEs in the wireless telecommunications system.

UDM 220 includes one or more devices that store user data and profiles in the wireless telecommunications system. UDM 220 may be used for fixed access and/or mobile access in core network 203.

PCF 225 includes one or more devices that provide a policy framework that incorporates network slicing, roaming, packet processing, and/or mobility management, among other examples.

AF 230 includes one or more devices that support application influence on traffic routing, access to NEF 210, and/or policy control, among other examples.

AMF 235 includes one or more devices that act as a termination point for non-access stratum (NAS) signaling and/or mobility management, among other examples.

SMF 240 includes one or more devices that support the establishment, modification, and release of communication sessions in the wireless telecommunications system. For example, SMF 240 may configure traffic steering policies at UPF 245 and/or may enforce UE Internet protocol (IP) address allocation and policies, among other examples.

UPF 245 includes one or more devices that serve as an anchor point for intraRAT and/or interRAT mobility. UPF 245 may apply rules to packets, such as rules pertaining to packet routing, traffic reporting, and/or handling user plane QoS, among other examples.

Message bus 250 represents a communication structure for communication among the functional elements. In other words, message bus 250 may permit communication between two or more functional elements.

Data network 255 includes one or more wired and/or wireless data networks. For example, data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of example environment 200 may perform one or more functions described as being performed by another set of devices of example environment 200.

FIG. 3 is a diagram of example components of a device 300 associated with onboarding a temporary subscriber onto a network. The device 300 corresponds to one or more of subscriber device 105, network device 120, and/or one or more devices associated with the core network 203 or the data network 255. In some implementations, the subscriber device 105, the network device 120, and/or one or more devices associated with the core network 203 or the data network 255 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

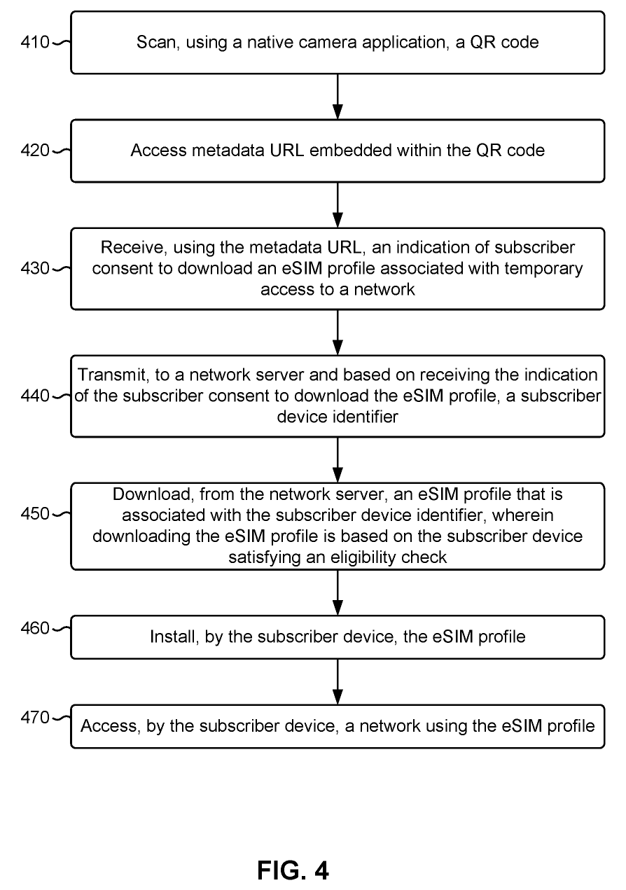

FIG. 4 is a flowchart of an example process 400 associated with onboarding a temporary subscriber onto a network. In some implementations, one or more process blocks of FIG. 4 may be performed by a subscriber device (e.g., subscriber device 105). In some implementations, one or more process blocks of FIG. 4 may be performed by another device or a group of devices separate from or including the subscriber device 105, such as a network device (e.g., network device 120), a UE, a RAN, a device associated with a core network (e.g., a device associated with core network 203, NSSF 205, NEF 210, AUSF 215, UDM 220, PCF 225, AF 230, AMF 235, SMF 240, and/or UPF 245), and/or a device associated with a data network (e.g., a device associated with data network 255). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include scanning a QR code (block 410). For example, the subscriber device 105 may scan a QR code, as described above. In some implementations, the QR code is configured to provide network access specific to a point of interest, such as point of interest 110, described above.

As further shown in FIG. 4, process 400 may include accessing a metadata URL embedded within the QR code (block 420). For example, the subscriber device 105 may access a metadata URL embedded within the QR code, as described above. In some implementations, the metadata URL is associated with a network’s subscriber provisioning and management platforms. Additionally, or alternatively, in some implementations, the metadata URL includes a URL associated with a customer registration page.

As further shown in FIG. 4, process 400 may include receiving an indication of subscriber consent to download an eSIM profile associated with temporary access to a network (block 430). For example, the subscriber device 105 may receive an indication of subscriber consent to download an eSIM profile associated with temporary access to a network, as described above.

As further shown in FIG. 4, process 400 may include transmitting a subscriber device identifier (block 440). For example, the subscriber device 105 may transmit a subscriber device identifier, as described above. In some implementations, the subscriber device identifier is associated with an EID.

As further shown in FIG. 4, process 400 may include downloading an eSIM profile that is associated with the subscriber device identifier, wherein downloading the eSIM profile is based on the subscriber device satisfying an eligibility check (block 450). For example, the subscriber device 105 may download an eSIM profile that is associated with the subscriber device identifier, wherein downloading the eSIM profile is based on the subscriber device 105 satisfying an eligibility check, as described above.

As further shown in FIG. 4, process 400 may include installing the eSIM profile (block 460). For example, the subscriber device 105 may install the eSIM profile, as described above. Additionally, or alternatively, process 400 may include enabling management of the eSIM profile via a web application after installation of the eSIM profile. For example, the subscriber device 105 may enable management of the eSIM profile via a web application after installation of the eSIM profile.

As further shown in FIG. 4, process 400 may include accessing a network using the eSIM profile (block 470). For example, the subscriber device 105 may access a network using the eSIM profile, as described above. In some implementations, accessing the network using the eSIM profile is associated with data-only access to the network. However, in some other implementations, process 400 includes transmitting, to the network server, identity verification information, and enabling voice-based access to the network based on transmitting the identity verification information.

Moreover, in some implementations, process 400 includes displaying a message indicating a duration of permitted access to the network. For example, the subscriber device 105 may display a message indicating a duration of permitted access to the network. Additionally, or alternatively, in some implementations, process 400 includes displaying a notification based on expiration of a permitted access to the network. For example, the subscriber device 105 may display a notification based on expiration of a permitted access to the network.

In some implementations, process 400 includes switching to another eSIM profile that is associated with another network based on expiration of a permitted access to the network. For example, the subscriber device 105 may switch to another eSIM profile that is associated with another network based on expiration of a permitted access to the network.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method for onboarding a temporary subscriber onto a network, comprising:
scanning, by a subscriber device using a native camera application, a quick response (QR) code;
accessing, by the subscriber device, a metadata uniform resource locator (URL) embedded within the QR code;
receiving, by the subscriber device and using the metadata URL, an indication of subscriber consent to download an embedded subscriber identity module (eSIM) profile associated with temporary access to a network;
transmitting, by the subscriber device to a network server and based on receiving the indication of the subscriber consent to download the eSIM profile, a subscriber device identifier;
downloading, by the subscriber device from the network server, an eSIM profile that is associated with the subscriber device identifier, wherein downloading the eSIM profile is based on the subscriber device satisfying an eligibility check;
installing, by the subscriber device, the eSIM profile; and
accessing, by the subscriber device, a network using the eSIM profile.

2. The method of claim 1, wherein the subscriber device identifier is associated with an embedded identity document.

3. The method of claim 1, wherein accessing the network using the eSIM profile is associated with data-only access to the network.

4. The method of claim 1, further comprising:
transmitting, by the subscriber device to the network server, identity verification information; and
enabling, by the subscriber device, voice-based access to the network based on transmitting the identity verification information.

5. The method of claim 1, wherein the metadata URL is associated with a network’s subscriber provisioning and management platforms.

6. The method of claim 1, wherein the QR code is configured to provide network access specific to a point of interest.

7. The method of claim 1, further comprising displaying, by the subscriber device, a message indicating a duration of permitted access to the network.

8. The method of claim 1, further comprising, displaying, by the subscriber device, a notification based on expiration of a permitted access to the network.

9. The method of claim 1, further comprising switching, by the subscriber device, to another eSIM profile that is associated with another network based on expiration of a permitted access to the network.

10. The method of claim 1, wherein the metadata URL includes a URL associated with a customer registration page.

11. The method of claim 1, further comprising enabling, by the subscriber device, management of the eSIM profile via a web application after installation of the eSIM profile.

12. A subscriber device, comprising:
one or more processors configured to:
scan, using a native camera application, a quick response (QR) code;
access a metadata uniform resource locator (URL) embedded within the QR code;
receive, using the metadata URL, an indication of subscriber consent to download an embedded subscriber identity module (eSIM) profile associated with temporary access to a network;
transmit, to a network server and based on receiving the indication of the subscriber consent to download the eSIM profile, a subscriber device identifier;
download, from the network server, an eSIM profile that is associated with the subscriber device identifier based on the subscriber device satisfying an eligibility check;
install the eSIM profile; and
access a network using the eSIM profile.

13. The subscriber device of claim 12, wherein accessing the network using the eSIM profile is associated with data-only access to the network.

14. The subscriber device of claim 12, wherein the metadata URL is associated with a network’s subscriber provisioning and management platforms.

15. The subscriber device of claim 12, wherein the QR code is configured to provide network access specific to a point of interest.

16. The subscriber device of claim 12, wherein the one or more processors are further configured to switch to another eSIM profile that is associated with another network based on expiration of a permitted access to the network.

17. A non-transitory computer-readable medium storing a set of instructions, the set of instructions comprising:
one or more instructions that, when executed by one or more processors of a subscriber device, cause the subscriber device to:
scan, using a native camera application, a quick response (QR) code;
access a metadata uniform resource locator (URL) embedded within the QR code;
receive, using the metadata URL, an indication of subscriber consent to download an embedded subscriber identity module (eSIM) profile associated with temporary access to a network;
transmit, to a network server and based on receiving the indication of the subscriber consent to download the eSIM profile, a subscriber device identifier;
download, from the network server, an eSIM profile that is associated with the subscriber device identifier based on the subscriber device satisfying an eligibility check;
install the eSIM profile; and
access a network using the eSIM profile.

18. The non-transitory computer-readable medium of claim 17, wherein the one or more instructions further cause the subscriber device to display a message indicating a duration of permitted access to the network.

19. The non-transitory computer-readable medium of claim 17, wherein the one or more instructions further cause the subscriber device to display a notification based on expiration of a permitted access to the network.

20. The non-transitory computer-readable medium of claim 17, wherein the one or more instructions further cause the subscriber device to switch to another eSIM profile that is associated with another network based on expiration of a permitted access to the network.
